(19) United States
(12) Patent Application Publication
(10) Pub. No.: US 2008/0246844 A1
(43) Pub. Date: Oct. 9, 2008

(54) Emergency and Alarm Lamp with a Video Camera

(76) Inventor: Sze Keun Chan, Hong Kong (CN)

Correspondence Address: KEVIN J. MCNEELY, ESQ., 5335 WISCONSON AVENUE, NW, SUITE 440, WASHINGTON, DC, 20015, US

(21) Appl. No.: 11/913,869

(22) PCT Filed: May 9, 2006
(86) PCT No.: PCT/CN06/00921

§ 371 Date: May 7, 2008

(30) Foreign Application Priority Data
May 9, 2005 (CN) 200520018059.X

(51) Int. Cl. H04N 7/18

(52) U.S. Cl. 348/152; 348/E07.085

(57) ABSTRACT

An emergency and alarm lamp with a video camera includes a lamp head, a lamp housing, and a lamp casing. The lamp head is a metal head with a general screw interface or a bayonet interface that can be fit on a lamp holder of a general filament lamp. The lamp housing is provided with a rechargeable battery, a manual/auto controller, a speech module, a speaker, a direct current converter, a controller, a power-cut inductor and a display for battery capacity. A hole is positioned on the central of the lamp casing, and a gas sensor is provided below the hole. A plurality of LEDs are arranged on two PCBs provided on the left and right sides of the lamp casing, respectively.

### CROSS REFERENCE TO RELATED APPLICATIONS

This U.S. national phase entry application claims priority to international application PCT/CN2006/000921 filed on May 9, 2006 and Chinese patent application 200520018059.X filed on May 9, 2005.

### TECHNICAL FIELD

This invention relates to a lamp and more particularly to a LED lamp, which comprises a rechargeable battery, a power-cutoff inductor, a human body detector, a gas sensor, and which has camcorder, alarm and/or emergency functionality.

### BACKGROUND ART

Typically, a lamp draws power from a transformer. When the power is on, the lamp works; while the power is cut-off, the lamp does not work. The lamp usually has a single lighting function; while some lamps with sound and human body sensors can only control the state of the lamp (on or off) to save power.

### SUMMARY

Nowadays, such safety protection facilities as a gas alert or camcorder are routinely installed in the workplace or in homes. So if these functions can be combined into one lamp, the cost and trouble of duplicate systems can be reduced. Furthermore, since lamps are ubiquitous, when the lamp has multi-functions, like lighting, alert, gas sensor, human detection, it can be beneficial in an emergency.

It is, therefore, an object of the invention, to solve the present technical shortage and to provide a kind of LED lamp with a rechargeable battery, which can provide power and supply the lamp when the primary or main power is cut off.

It is another object of the invention to provide the power-cutoff inductor, which will send a message to CPU and make an alert, reminding users to turn off electric devices when there is a power cutoff or outage.

It is another object of the invention to provide a human body detector, which will send a signal to the CPU when it detects that the human is in the detection area at the emergency. The CPU sends a lighting signal to the lamp to turn on and an alarm to remind the person that he or she is in danger.

It is another object of the invention to provide a gas sensor, which sends a signal to the CPU when there is hazardous gas in the detection area. The CPU then controls the audio module to send out an alarm and triggers a red LED to flash. It is another object of the invention to provide a mechatronic camera, taking a track recording or timed recording.

The system includes a lamp holder, a lamp housing, and a lamp casing. The lamp holder is a metal holder with a threaded interface or a bayonet interface that can be fit on a holder of a general filament lamp. The lamp housing is provided with a rechargeable battery, a manual/auto controller, a audio module, a speaker, a direct current converter, a controller, a power-cutoff inductor and a display to indicate the battery capacity. A hole is positioned on the center of the lamp casing, and a gas sensor is provided below the hole. A plurality of LEDs are arranged on two PCBs provided on the left and right sides of the lamp casing, respectively. A red LED flasher is arranged on the each PCB and covered with a transparent shield. Two human body detectors are arranged at the left-most end and the right-most end respectively. Between the two transparent shields, there is a filter in which there is a video camera.

A rechargeable battery is used to maintain power and supply the lamp at the time of a power outage. After AC power turns into DC power through the direct current converter, it charges the battery by the controller. The CPU detects the battery capacity and decides if it will charge the battery or not. The CPU and the controller exchange signals to control the state (on/off) of the battery charger. The DC power supplies other modules through the controller. When the power is cut off, the controller triggers the battery supply in 0.5 second (configurable).

The power-cutoff inductor is used for power outage detection, in order to send a message to the CPU at the time of a power outage and trigger the audio module in a configured timeframe, then the speaker sends out the alert, and the red LED flashes, reminding users to turn off the electric device and avoid the danger.

The human body detector, which is used to detect a human body, can be an ultrasonic detector or an infrared detector. When there is human body in the detection area, the camera will record. The detector send a signal to the CPU when it detects that a human is in the detection area at the emergency. The CPU will trigger the audio module, then the speaker sends out the alarm, the red LED flashes, alerting that the human is in a dangerous area and should exit as soon as possible or informing the people outside of human presence inside.

The gas sensor is used to detect hazardous gas in a certain area. When hazardous gas is present and reaches the sensor through the hole, the sensor will send message to CPU. The CPU will trigger the audio module, then the speaker sends out the alarm, the red LED flashes, alerting that the human is in a hazardous gas area and needs to take effective measurements to avoid danger to life.

The camera may be a mechatronic camera. When the human body detector sends the human existence signal to CPU, the CPU will give signal to camera controller, drive the motor M1 to correct direction and the motor M2 to correct angle and focus, taking the track record or timed record.

A manual/auto controller is to adjust the lighting angle, send the alarm or turn on/off the power automatically or manually. A radio receiver receives the radio signal and data. The LED can be replaced by an LED chip or microchip or any other lighting component. The audio module has pre-configured speech or a specific alarm sound. The speaker can be a buzzer or electromagnetic or mini speaker.

The CPU can transmit data from the human body detector and camera to certain facilities via the power cord. The lamp holder can be a generic version, so no replacement is needed. Because the large capacity rechargeable battery is used, it can be used when the power is cut off; moreover, because it is multi-functional, it can be removed from the lamp holder and used as a portable lighting, detection or alarm tool.

For a better understanding of the invention, the objects, characteristics and advantages of the invention can be illustrated in more details in the drawing and description.

### BRIEF DESCRIPTION OF THE DRAWINGS

FIG. 1 is a structure chart of the invention;

FIG. 2 is a structure chart of the another embodiment of the invention;

FIG. 3 is a circuit diagram of the invention;

Elements of the drawings are identified with the following numbers: 1—lamp head; 2—lamp housing; 3—lamp casing; 4—transparent shield; 5—rechargeable battery; 6—manual/auto controller; 7—audio module; 8—speaker; 9—direct current converter; 10—controller; 11—power-cutoff inductor; 12—display for battery capacity; 13—human body detector; 14—gas sensor; 15—hole; 16—regulator; 17—PCB; 18—red LED; 19—white LED; 20—video camera; 21—filter; 22—CPU; and, 23—radio receiver.

### DETAILED DESCRIPTION

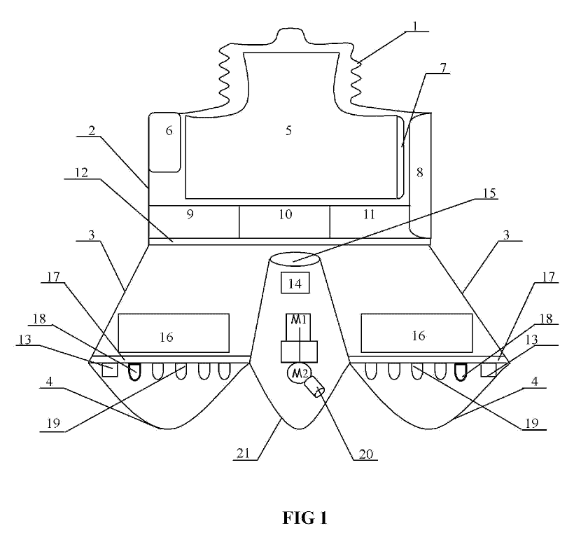

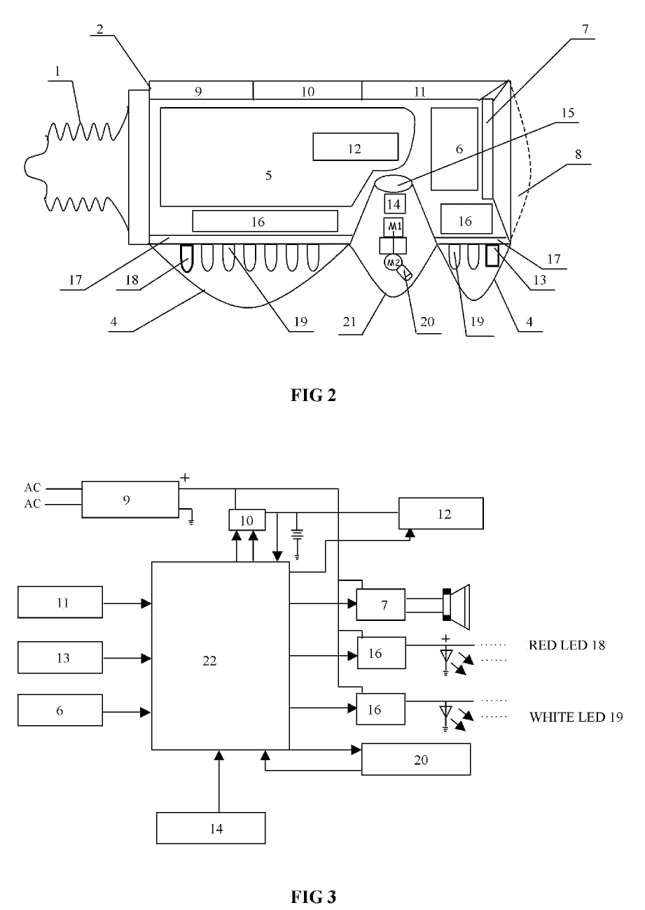

As shown in FIGS. 1 and 2, the invention comprises lamp head (1), lamp housing (2), lamp casing (3), transparent shield (4) which is featured in: the lamp head (1) is a threaded interface or a bayonet interface that can be fit on a holder of a general filament lamp; the lamp housing (2) has rechargeable battery (5), manual/auto controller (6), radio receiver (23), audio module (7), speaker (8), direct current converter (9), controller (10), power-cutoff inductor (11) and battery capacity display (12) installed inside; the lamp casing (3) has a vent hole (15) in the middle, under which, the gas sensor (14) is installed. A plurality of LEDs are installed on both sides of the PCBs (17), among which, there is one red LED (18) installed on each side. LEDs are covered with transparent shield (4). Two human body detectors (13) are arranged at the left-most end and the right-most end respectively. Between the two transparent shield (4)s, there is a filter (21) under which there is a video camera (20).

The lamp housing (2) is made of insulating materials. The lamp casing (3) is made of heat conductive material.

The rechargeable battery (5) is used to maintain power and supply the lamp at the time of a power outage. After AC power turns into DC power through the direct current converter (9), it charges the battery by the controller (10). The CPU (22) will detect the battery capacity and decide if it will charge the battery or not. The CPU and the controller exchange signals for the on/off state of the battery charge. When the charge is off, the battery capacity display (12) shows the battery is full. The DC power will supply other modules through the controller (10). When the power is cut off, the controller (10) will trigger the battery supply in 0.5 second (configurable). Solar power or other kinds of power can also be used in the invention.

The power-cutoff inductor (11) is connected to a CPU on one of the PCBs to control the backup power from the rechargeable battery. It is used to detect a power outage, which will send a message to the CPU (22) at the time of a power outage and trigger the audio module (7) in a configured timeframe, then the speaker (8) sends out the alert, the red LED (18) turns on and flashes, reminding users to turn off electric devices and avoid the danger.

The human body detector (13), which is used to detect a human body, can be an ultrasonic detector or an infrared detector. The detector (13) will send signal to CPU (22) when it detects that a human body is in the detection area at the emergency. The CPU (22) will trigger the audio module (7), then the speaker (8) sends out the alarm, the red LED (18) turns on and flashes, alerting that the human is in a dangerous area and should exit as soon as possible or informing the people outside the human presence inside.

The gas sensor (14) is used to sense hazardous gas in a certain area. When the hazardous gas occurs and reaches the sensor (14) through the hole (15), the sensor (14) will send a message to CPU (22). The CPU (22) will trigger the audio module (7), then the speaker (8) sends out the alarm, the red LED flashes (18), alerting that the human is in hazardous gas area and needs to take effective measures to avoid danger to life.

The camera (20) is a mechatronic camera. When human body detector (13) sends a human detection signal to CPU (22), the CPU will give signal to camera (20) controller, drive the motor M1 to correct direction and the motor M2 to correct angle, focus and lighting conditions, taking the track record or timed record.

The manual/auto controller (6) adjusts the lighting angle, sends the alarm activation signal and turns on/off the power automatically or manually. The radio receiver (23) receives radio signals and data. The audio module (7) is a 1000 HZ speech module and has pre-configured speech or a specific alarm sound. The speaker (8) can be a buzzer or an electromagnetic or mini speaker, which will receive the data transmitted from audio module (7). The regulator (16) is connected with PCB (17) and protects LED (18) and LED (19) from the wrong voltage. The red LED (18) and white LED (19) can be replaced by an LED chip or microchip or any other lighting components, the white LED (19) can be replaced by other colors except red. The LED (19) or LED microchips can be integrated on or in an astigmatism plate to acquire even lighting.

The lamp of the invention can be can be made into a variety of shapes such as a ceiling lamp panel or a pendant lamp.

The lamp holder can be conventional, so no replacement is needed. Because the large capacity rechargeable battery is used, it can be used when the power is cut off; moreover, because it is multi-functional, it can be removed from the lamp holder and used as a portable lighting, detection or alarm tool.

While there have been shown and described above what are at present considered to be the preferred modes of carrying out the invention, it will be apparent to those skilled in the art that various changes and modification can be made herein without departing from the scope of the invention as defined by the claims.

What is claimed is:

1. An emergency and alarm lamp with a video camera, comprising:
a lamp head with a threaded interface or a bayonet interface to be installed in a lamp socket of a general filament lamp;
a lamp housing attached to the lamp head, the lamp housing enclosing
a rechargeable battery,
a manual/auto controller,
a radio receiver,
an audio module,
a speaker,
a direct current converter,
a controller,
a power-cutoff inductor, and
a battery capacity display;
a lamp casing attached to the lamp housing, the lamp casing having
a pair of transparent shields, and
a filter positioned between the pair of transparent shields,
and the lamp casing enclosing
a gas sensor installed under a vent hole,
printed circuit boards (PCBs) that control lighting sources,
human body detectors arranged at the left-most end and the right-most end respectively, and
a video camera positioned under the filter.

2. The device of claim 1, wherein a controller connects the rechargeable battery to a direct current converter.

3. The device of claim 1, wherein the power-cutoff inductor is connected to a central processing unit (CPU) on one of the PCBs to control the speaker, a red LED and backup power from the rechargeable battery.

4. The device of claim 1, wherein the human body detectors are connected to a central processing unit (CPU).

5. The device of claim 1, wherein the gas sensor is connected to a CPU.

6. The device of claim 1, wherein the camera is mechatronic with motors that adjust camera settings for view, focus and lighting conditions.

7. The device of claim 1, wherein the audio module is a 1000 HZ speech signal module.

8. The device of claim 1, wherein the speaker is a buzzer or an electromagnetic or a mini speaker

9. The device of claim 1, wherein a regulator is connected with a PCB, red LEDs, and white LEDs.

10. The device of claim 1, wherein:
the illumination sources comprise LEDs, and
the PCBs further comprise a plurality of LEDs on both sides, including a red LED installed on each side.

11. The device of claim 1, wherein the illumination sources comprise thin LED chips.

12. The device of claim 1, wherein the illumination sources comprise LED microchips.

13. The device of claim 1, wherein the illumination sources comprise LEDs.
